(19) United States
(12) Patent Application Publication
(10) Pub. No.: US 2026/0192277 A1
(43) Pub. Date: Jul. 9, 2026

(54) METHODS AND APPARATUS FOR INCUBATING DROPLETS

(71) Applicant: Agilent Technologies, Inc., Santa Clara, CA (US)

(72) Inventors: Jeffrey R Sampson, San Jose, CA (US); Reid A Brennen, San Francisco, CA (US); Richard K Workman, Sunnyvale, CA (US); Richard P Tella, Sunnyvale, CA (US)

(21) Appl. No.: 19/134,126

(22) PCT Filed: Dec. 28, 2023
(86) PCT No.: PCT/US2023/086186

§ 371 Date: May 29, 2025

Related U.S. Application Data
(60) Provisional application No. 63/436,021, filed on Dec. 29, 2022.
(60) Provisional application No. 63/482,943, filed on Feb. 2, 2023.
(60) Provisional application No. 63/589,580, filed on Oct. 11, 2023.

(51) Int. Cl. B01J 19/00

(52) U.S. Cl. CPC B01J 19/0046; B01J 2219/00333; B01J 2219/00385; B01J 2219/00495; B01J 2219/00722

(57) ABSTRACT

Biopolymers are synthesized on a substrate in a manner that that reduces droplet evaporation including at elevated temperatures. The substrate is enclosed by a lid that form an incubation chamber that is effective to impair evaporation of droplets being dispensed and to provide vapor and temperature adjustments. The biopolymer synthesis may be implemented, for example, as part of the fabrication of a microarray which may be the product of DNA or RNA array printing and for oligonucleotide library synthesis, by chemical and enzymatic procedures.

### CROSS-REFERENCE TO RELATED APPLICATIONS

This application claims priority to and benefit of U.S. Patent Application No. 63/436,021, filed on Dec. 29, 2022, U.S. Patent Application No. 63/482,943, filed on Feb. 2, 2023, U.S. Patent Application No. 63/589,580, filed on Oct. 11, 2023, the contents of which are incorporated herein by reference in their entireties.

### TECHNICAL FIELD

The present invention generally relates to processing droplets, such for oligonucleotide synthesis using droplets on a substrate.

### BACKGROUND

A liquid dispensing (or deposition) device may be utilized to dispense one or more droplets onto one or more locations on a solid substrate such as a glass slide. A common example of a liquid dispensing device is a printer such as an inkjet printer. Depending on the application that requires the liquid dispensing, the droplets dispensed may be small, for example, on the order of microliters (μL), nanoliters (nL), or picoliters (pL) in volume. Once the dispensed droplets are deposited onto the substrate, the deposited droplets may be on the order of micrometers (μm) in size (e.g., diameter) or smaller. Some applications involve the dispensing of droplets as part of fabricating a DNA or RNA microarray or synthesizing a library of oligonucleotides on a substrate, in which case the droplets dispensed may be, for example, around 10 pL in volume and the resulting droplets on the substrate may be (initially) around 35 μm in diameter. At such small scales, the droplets dispensed may evaporate in a few minutes or even a few seconds after being emitted from the liquid dispensing device due to their exposure to an open environment. Evaporation of the droplets reduces their size until, ultimately, no liquid phase remains if the evaporation is allowed to continue. The rapid evaporation of the droplets is due to their large surface-area-to-volume ratio and vapor pressure. The rate of evaporation also depends on the composition of the droplets and the operating environment or conditions under which the droplets are dispensed (e.g., temperature, humidity, partial pressure of the dispensed liquid etc.) in which the droplets are dispensed. For example, droplets including water may evaporate completely in a few seconds after being emitted from the liquid dispensing device.

Oligonucleotides are commercially available based on chemical synthesis. When either many sequences are needed, such as for libraries or arrays, or minute quantities of individual sequences are required, these oligonucleotides are typically chemically synthesized by deposition of phosphoramidite and activator in propylene carbonate in discrete locations on a substrate. More recently enzymatic synthesis has been reported which typically utilizes engineered versions of terminal deoxynucleotidyl transferase (TdT) or other polymerases to cyclically add a nucleotide to the end of a DNA strand to synthesize a desired sequence. Enzymatic oligonucleotide synthesis has been conducted within a single well of a well plate or in a column, and it typically employs aqueous solvents. Water has a vapor pressure more than 500 times higher than propylene carbonate, so droplets of aqueous solvent tend to evaporate much more quickly than droplets comprising solvents currently used for chemical synthesis of oligonucleotides.

Therefore, there is a need for addressing the evaporation of droplets during incubation during biopolymer synthesis, particularly when the droplets comprise solvents having high vapor pressures and/or when the synthesis occurs at elevated temperatures. It would be advantageous to synthesize oligonucleotides by enzymatic synthesis using picoliter-scale droplets on a substrate.

### SUMMARY

To address the foregoing needs, in whole or in part, and/or other needs that may have been observed by persons skilled in the art, the present disclosure provides methods, processes, systems, apparatus, instruments, and/or devices, as described by way of example in implementations set forth below.

As an aspect of the present invention, an apparatus is provided for incubating droplets on a surface of a substrate. The apparatus comprises (a) a substrate stage for moving the substrate from a dispensing region to an incubating region; (b) a liquid dispensing device in the dispensing region comprising a plurality of dispensing elements for dispensing droplets; and (c) an incubation lid in the incubating region configured for moving between open and closed positions with respect to the substrate. The incubation lid and the substrate form an incubation chamber when the incubation lid is in a closed position.

As another aspect of the present invention, a method is provided for incubating droplets. The method comprises dispensing droplets onto a top surface of a substrate while the substrate is positioned in a dispensing region; moving the substrate to an incubating region; forming an incubation volume that substantially encloses the droplets; and incubating the droplets in the incubation volume.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a top plan view of an example of a microarray according to an implementation of the present disclosure.

FIGS. 2A and 2A are elevational views of an example of an apparatus for biopolymer synthesis comprising a dispensing region and an incubating region, according to an implementation of the present disclosure.

FIG. 3 is an elevation view of an apparatus for droplet incubation and biopolymer synthesis, according to an implementation of the present disclosure.

FIG. 4 is an elevation view of another example of an apparatus for droplet incubation and biopolymer synthesis, according to an implementation of the present disclosure.

FIGS. 5A and 5B are images of water droplets on a glass substrate in an incubation chamber.

FIGS. 6A and 6B show a perspective view of another embodiment of the apparatus comprising an incubation lid and an inflatable seal.

FIGS. 7A and 7B show a side view of another embodiment of the apparatus comprising an incubation lid and an inflatable seal.

The illustrations in all of the figures are considered to be schematic, unless specifically indicated otherwise.

### DETAILED DESCRIPTION

In this disclosure, all “implementations,” “aspects,” “examples,” and “embodiments” described are considered to be non-limiting and non-exclusive. Accordingly, the fact that a specific “implementation,” “aspect,” “example,” or “embodiment” is explicitly described herein does not exclude other “implementations,” “aspects,” “examples,” and “embodiments” from the scope of the present disclosure even if not explicitly described. In this disclosure, the terms “implementations,” “aspect,” “example,” and “embodiment” are used interchangeably, i.e., are considered to have interchangeable meanings.

In this disclosure, the term “substantially,” “approximately,” or “about,” when modifying a specified numerical value, may be taken to encompass a range of values that include +/−10% of such numerical value, unless specifically indicated otherwise.

In this disclosure, the term “liquid” encompasses a single liquid-phase composition or a mixture or blend of two or more liquid-phase compositions. Examples of a liquid include, but are not limited to, a solution, a suspension, a colloid, or an emulsion. A liquid may contain or carry solid particles (e.g., inorganic particulates, whole biological cells or lysed cell components, etc.) and/or gas or vapor bubbles.

In this disclosure, the term “(bio) chemical compound” encompasses chemical compounds and biological compounds (or biomolecules). A chemical compound may be, for example, a small molecule or a high molecular-weight molecule (e.g., a polymer, carbohydrate, sugar, etc.). A biological compound may be, for example, a biopolymer. Examples include, but are not limited to, nucleic acids (or polynucleotides), such as deoxyribonucleotides, ribonucleotides, oligonucleotides (or “oligos”), proteins, and analogs or derivatives of the foregoing. The present disclosure uses oligonucleotides in describing the details of various methods and apparatus, but it should be understood that these descriptions are applicable to other biopolymers in place of oligonucleotides, such as proteins, carbohydrates and others.

In this disclosure, the term “interaction” generally refers to an interaction between two or more components, where the components taking part in the interaction may be one or more elements, one or more molecules, or a combination of one or more elements and one or more molecules. The term “interaction” encompasses (bio) chemical reactions, including (bio) chemical synthesis.

The term “connected” means that two components are fluidically connected, or physically connected, or both. The term “fluidically connected” means that two components are in fluid communication and includes direct connections between the two components as well as indirect connections where one or more other components are in the flow path between the two components. For example, a first component and a second component are fluidically connected if an outlet from the first component is physically connected to an inlet of the second component, or if a conduit connects the first and second components, or if one or more intervening components, such as a valve, a pump, or other structure, is between the two components as fluid flows from the first component to the second component, or vice versa. Components can be physically connected in any suitable way, such as by using ferrules, brazing, and other approaches. In general, physical connections that are fluid-tight and/or that minimize dead-volume are desired for the present devices.

It will be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

In this disclosure, the term “flowpath” generally refers to any structure configured to provide for fluid flow. The flowpath may be a conduit or a channel formed in a body. A flowpath may be formed by or comprise one or more conduits or channels in fluid communication. The geometry of a flowpath may vary widely and includes circular, rectangular, square, D-shaped, trapezoidal or other polygonal cross-sections. A flowpath may comprise varying geometries (e.g., rectangular at one section and trapezoidal at another section). In some embodiments, the cross-sectional area of a flowpath used is substantially constant.

As used in the specification and appended claims, the terms “a,” “an,” and “the” include both singular and plural referents, unless the context clearly dictates otherwise. Thus, for example, “a component” includes one component and plural components. The terms “first” and “second” are terms to distinguish different elements, not terms supplying a numerical limit, and a device having first and second element can also include a third, a fourth, a fifth, and so on, unless otherwise indicated.

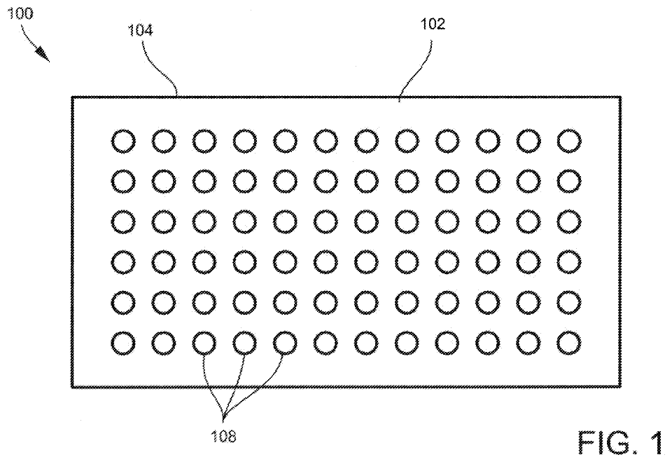

FIG. 1 is a top plan view of an example of an array (or microarray) 100 that may be fabricated by devices, systems and methods described in the present disclosure. The microarray 100 includes a solid substrate 104, and a one-dimensional (1D) or (more typically) two-dimensional (2D) array of liquid-containing spots 108 (or features, or liquid deposition sites, or “virtual wells,” etc.) disposed on a top surface 112 of the substrate 104. The microarray 100 may be configured for various applications in fields such as, for example, immunoassays, genomics, proteomics, cell analysis, disease diagnosis or other disease analysis or prediction, drug discovery, combinatorial chemistry, etc.

The substrate 104 is configured as a solid support for droplet deposition, which may be part of microarray fabrication as noted above. That is, the substrate 104 (or at least its top surface 112) may be composed of any solid material suitable for serving as a solid support for the (bio) chemical interactions carried out at the sites of the liquid spots 108, which interactions are application-dependent. As one example, the (bio) chemical interactions may be part of deoxyribonucleic acid (DNA) or ribonucleic acid (RNA) synthesis. Examples of the material of the substrate 104 include, but are not limited to, various glasses, quartz or fused silica, polymer-coated glasses, polymers (e.g., poly(methyl methacrylate) or PMMA, polydimethylsiloxane or PDMS, SU-8, etc.), ceramics, and silicon. The top surface 112 of the substrate 104 may be derivatized/functionalized/modified as needed for a particular application, as appreciated by persons skilled in the art. For example, the substrate 104 may be pretreated to render the top surface 112 hydrophobic and thereby optimize the formation of uniform or homogeneous spots 108. In other words, after dispensed droplets contact designated spots 108 on the top surface 112, the droplets are uniformly sized and maintain a substantially dome shape. Silanized glass is one example of a pretreated substrate 104. As another example, a substrate 104 may be pretreated in the sense that spots 108 are initially formed with a starting material (e.g., a biochemical probe, a pad configured to facilitate oligonucleotide extension, etc.) prior to implementation of any of the liquid dispensing methods disclosed herein.

The substrate 104 is typically (but not necessarily) planar or plate-shaped, meaning that the thickness (in the direction of the drawing sheet) of the substrate 104 is the smallest physical dimension in comparison to the length and width of the substrate 104 in the horizontal plane shown in FIG. 1. As such, in various implementations, the substrate may be characterized as plate, slide, chip, etc. The substrate 104 is typically (but not necessarily) rectilinear, as shown in FIG. 1.

In the present example, the top surface 112 of the substrate 104 is a flat, continuous surface and the spots 108 define virtual wells as opposed to actual, structural wells formed in the substrate 104. In other implementations, however, the substrate 104 may include actual wells that serve as individually addressable sites for receiving dispensed droplets. In other words, the spots 108 may be located in actual wells of the substrate 104. In other implementations, spots 108 may be raised above the surface of substrate 104.

The composition of the spots 108 depends on the application being implemented and the current stage or step of the application being implemented. Typically (but not necessarily), the spots 108 are liquid-phase solutions containing the product of one or more (bio) chemical interactions that have been carried out during the process of microarray fabrication. For example, in the case of DNA or RNA microarray fabrication, the spots 108 may be or include DNA or RNA probes immobilized on the top surface 112 of the substrate 104, and target molecules bound to the DNA or RNA probes. Protein-based arrays may also be fabricated by application of the subject matter disclosed herein, such as for analyzing protein-protein or protein-ligand interactions. As another example, the spots 108 may be or include the results of non-biological chemical reactions, synthesis, or other type of interaction between (bio) chemical compounds. More generally, the composition of the spots 108 may vary during a liquid dispensing or array fabrication process. For example, the composition of the spots 108 may differ at different, intermediate stages of an array fabrication process. Depending on the stage of an array fabrication process, the spots 108 may or may not be dry at the time a droplet dispensing step is performed.

The number of rows and columns of spots 108 and the total number of spots 108 shown in FIG. 1 is merely illustrative. The number of spots 108 may range from a few (e.g., 10) to one hundred or a few hundred (e.g., for diagnostic applications), or to hundreds of thousands or several million (e.g., for high-throughput research or screening applications). The spacing between adjacent spots 108 is typically uniform throughout the array although this is not a requirement. The spacing between adjacent spots 108 is large enough to avoid cross-contamination between adjacent spots 108 or merging of adjacent spots 108, and to enable the spots 108 to be spatially discrete and individually identifiable (e.g., individually addressable by detection/imaging technology). As examples, the volume of a droplet deposited on the substrate 104 may be on the order of picoliters (pL) (e.g., in a range from 1 or a few pL to 1000 pL) or nanoliters (nL) (e.g., in the range from 1 or a few nL to 1000 nL), the diameter of a resulting spot 108 on the substrate 104 and the spacing between adjacent spots 108 may be on the order of micrometers (μm) (e.g., in a range from 1 or a few μm to 1000 μm), and the density of the spots 108 in the microarray 100 may be on the order of a few thousand, tens of thousands, or several hundred thousands of spots 108 per square centimeter (cm²). The constructed microarray may be used as a means to fabricate individual or libraries of molecules which may be subsequently used as a microarray or wholly or partially cleaved from the surface 112.

Examples of microarray fabrication are described in, for example, U.S. Patent App. Pub. Nos. 2008/0206850 and 2008/0085513; U.S. Pat. No. 8,778,849, the entire contents of each of the foregoing being incorporated by reference herein. Examples of oligonucleotide library synthesis (OLS) are described in, for example, U.S. Patent App. Pub. Nos. 2012/0220497; 2016/0310927; 2019/0118154; and 2021/0129108, the entire contents of each of the foregoing being incorporated by reference herein. Examples of enzymatic synthesis of nucleic acids are described in, for example, U.S. Patent App. Pub. Nos. 2016/0046973 and 2019/0112626, the entire contents of each of the foregoing being incorporated by reference herein.

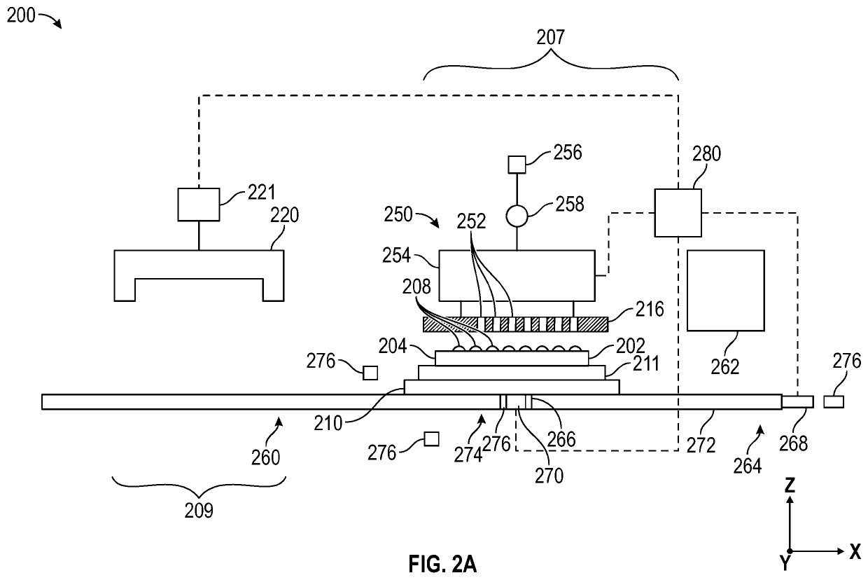

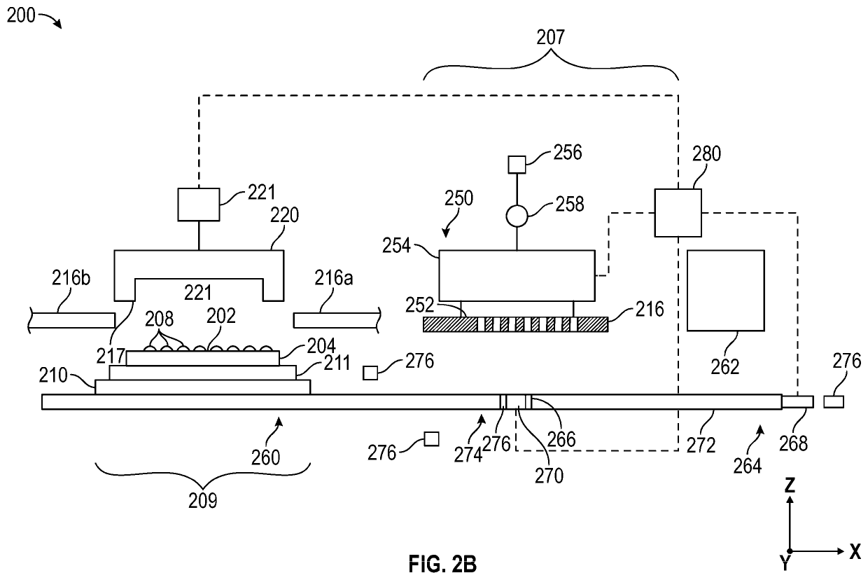

As one aspect of the present disclosure, an apparatus is provided for synthesizing oligonucleotides or other biopolymers on a surface of a substrate. FIGS. 2A and 2B are elevational views of an example of an apparatus for biopolymer synthesis comprising a dispensing region and an incubating region. For purposes of description, FIGS. 2A and 2B include an arbitrarily located Cartesian coordinate (X-Y-Z) frame of reference.

FIGS. 2A and 2B are schematic views of an example of the apparatus, in which a substrate 204 is provided on a substrate stage 210 which holds and moves the substrate 204 from a dispensing region 207 to an incubating region 209. The substrate stage 210 can directly hold the substrate 204, such as within a cavity on the stage surface, or a substrate holder 211 can be attached to or integral with the substrate stage 210 or an essentially flat surface (i.e., without any cavity) of the substrate stage 210. In the dispensing region 207, a liquid dispensing device 250 is configured to dispense droplets 208 onto a top surface 202 of the substrate 204. The liquid dispensing device 250 can include one or more dispensing elements 252, such as one or more printheads 254 for inkjet printing of droplets. The apparatus can include an evaporation cover 216 which forms a small, at least partially enclosed volume in which the spots 208 reside. With this small, partially enclosed volume, as the droplets evaporate, the evaporation rate of the droplets quickly comes to equilibrium with the condensation rate.

In some embodiments, the present apparatus includes an evaporation cover 216, as described in U.S. Application No. 63/436,058 (Docket No. 20220020-01), filed on Dec. 29, 2022. After spots 208 (droplets) are dispensed onto the substrate 204, the substrate stage 210 can move the substrate 204 to incubating region 209 (as illustrated in FIG. 2B), where an incubation lid 220 can be positioned to form a substantially enclosed incubation chamber. Evaporation cover 216 can create a head space in a dispensing region and/or between the dispensing region 207 and the incubating region 209.

In the illustrated example, the liquid dispensing device 250 is configured as a printer that includes one or more printheads 254 each supporting an array of dispensing (printing or writing) elements 252. The apparatus may include or be fluidically connected to one or more liquid reservoirs 256 containing respective liquids to be dispensed, and one or more liquid flow devices 258 (e.g., pumps) configured to establish flows of liquid from the liquid reservoirs 256 to the dispensing elements 252. The liquid reservoir(s) 256 and the liquid flow device(s) 258 may or may not be integrated with the printhead(s) 254, depending on the implementation.

The apparatus 200 for biopolymer synthesis may also include a staging assembly 260 (or motion control system) configured to move (transport) the substrate holder 211, and thus the substrate 204 supported thereon, along one or more axes. In particular, the staging assembly 260 is configured to move the substrate 204 to the above-described internal or operating position that establishes the dispensing region 207 and places the substrate 204 in proper alignment with the dispensing elements 252 in preparation for intended dispensing operations. The staging assembly 260 may also be configured to move the substrate holder 211 and substrate 204 to one or more external positions, such as other stations (e.g., incubating region 209 or other station 262 of apparatus 200). The incubating region 209 and other stations 262 may be configured for further processing of the droplet-containing substrate 204.

In some implementations, the step of incubating the droplets initiates and/or promotes an interaction between two or more components, and at least one of the two or more components is initially part of the droplets, or initially part of spots present on the top surface prior to the dispensing and on which the droplets are dispensed. For example, when the droplets comprise one or more reagents for oligonucleotide synthesis or for synthesis other biopolymers, the incubating step can initiate and/or promote one or more synthesis reactions. Examples of reagents for enzymatic oligonucleotide synthesis include, starter sequences, nucleotide triphosphates or degenerate nucleotides, enzymes, and others. In some implementations, first droplets comprising a first reagent are dispensed onto a substrate in the dispensing region, the substrate is moved to the incubating region where a biopolymer synthesis reaction occurs, the substrate is moved back to the dispensing reagent, and second droplets comprising a second reagent are dispensed on the substrate. This can be followed by a second incubating step, dispensing of third droplets containing a third reagent, a third incubating step, dispensing of fourth droplets, a fourth incubating step, and so on. The steps of dispensing series of droplets (e.g., first droplets, second droplets, third droplets, and fourth droplets) followed by incubation can be repeated until oligonucleotides of desired lengths are synthesized on the substrate. The order or sequence of the movements of the substate 204 performed by the apparatus 200 (in particular the staging assembly 260), and the number of times (iterations) that one or more of these movements are repeated or cycled during a given operational procedure, depend on the particular application or method being implemented.

In some implementations, incubation comprises adjusting a temperature of the droplets (such as by adjusting a temperature of the incubation volume and/or the substrate). Incubation can be comprised of adjusting the temperature to a desired temperature and/or for a desired period, such as for one or more steps or reactions during an incubation period or a portion thereof. It is contemplated that temperatures and periods are selected based on the components of the droplets and the steps or reactions desired. In the present methods and apparatus, the droplets can be present in an incubation region for any desired time or purpose. In some embodiments, the droplets remain in the incubation region for one or more incubation periods, which can be predetermined or determined based on one or more prior or contemporaneous conditions or parameters. In some implementations, the incubation period is predetermined based on the components of the droplets dispensed on the substrate. For example, when the droplets comprise nucleotide triphosphate or degenerate nucleotides and an enzyme such as terminal deoxynucleotidyl transferase, the incubation temperature and the incubation period are selected to allow or enhance can be from 20° C. to 80° C. and the incubation period can be from 1 seconds to 600 seconds or more.

In some implementations, the present apparatus comprises a stage actuator for moving the substrate stage in one or more directions. The stage actuator can comprise one or more drive assemblies for moving a substrate stage back and forth on one or more axes. In the present example, the stage actuator comprises a staging assembly 260 which include an X-axis (or first axis) drive assembly 264, a Y-axis (or second axis) drive assembly 266, and a movable stage 210. The X-axis drive assembly 264 is configured to move the substrate holder 211 and substrate 204 back and forth along the X-axis, in particular to and from the liquid dispensing device 250 and dispensing region 207. The Y-axis drive assembly 266 is configured to move the substrate holder 211 and substrate 204 back and forth along the Y-axis, which may be useful for various functions. For example, the Y-axis drive assembly 266 along with the X-axis drive assembly 264 may be utilized to accurately and repeatedly position the substrate 204 in the correct location in the X-Y plane relative to the dispensing elements 252. As another example, either the Y-axis drive assembly 266 or the X-axis drive assembly 264 may be useful for facilitating the loading of the substrate(s) 204 onto the substrate holder 211 and/or the removal of the substrate(s) 204 from the substrate holder 211. The staging assembly 260 may also include a Z-axis (or third axis) drive assembly (not shown) if needed to adjust the vertical position of the substrate 204 relative to the dispensing elements 252 and/or the evaporation cover 216, and/or relative to other instruments or devices of the liquid dispensing system 250. The staging assembly 260 may also include a drive assembly for rotation of the substrate 204 around one or more of the X-, Y- and Z-axes.

The X-axis drive assembly 264 includes an X-axis driver 268 (including, for example, a bidirectional stepper motor or servo motor) configured to drive movement of a linear guide and transmission linkage 272 (e.g., belt and pulley, chain and cog, screw and worm gear, etc.). Similarly, the Y-axis drive assembly 266 includes a Y-axis driver 270 (including, for example, a bidirectional stepper motor or servo motor) configured to drive movement of a linear guide and transmission linkage 274 (e.g., belt and pulley, chain and cog, screw and worm gear, etc.). In the illustrated example, the substrate 204 (or the substrate 204 as attached to the substrate holder 211 and, in turn, the movable stage 210) is coupled directly to the Y-axis drive assembly 266, which is in turn coupled to the X-axis drive assembly 264. Alternately, the substrate 204 may be coupled via the movable stage 210 directly to the X-axis drive assembly 264, which in turn is coupled to the Y-axis drive assembly 210. More generally, persons skilled in the art will appreciate that various other alternative configurations for the staging assembly 260 as a motion control system may be implemented to realize controlled motion of the substrate 204 along the desired axis or axes.

The incubation lid 220 is configured for, or connected to a lid actuator 221 for, moving between open and closed positions with respect to the top surface 202 of the substrate 204 (or with respect to a substrate stage 210 and/or substrate holder 211). For instance, the incubation lid 220 can be connected to a lid actuator 221 for moving the incubation lid 220 along a Z-axis with respect to the substrate 204. When the incubation lid 220 is in a closed position, the incubation lid 220 and the substrate 204 and/or the substrate stage 210 form an incubation chamber that defines an incubation volume. The incubation lid 220 can be moved to an open position, such as when the substrate 204 is moved into or out of the incubating region 209. While it will be generally convenient for the incubation lid 220 to have at least one open position to facilitate movement of the substrate 204 into and out of the incubating region 209, and at least one closed position to form an incubation volume, it is also contemplated that the present apparatus may not require an open position for the incubation lid, and/or that the present apparatus may have more than one closed position for the incubation lid.

In some implementations, evaporation cover 216 extends toward the incubating region 209 and/or comprises evaporation cover portions 216a, 216b that substantially surround the incubating region 209. Evaporation cover 216 can comprise one or more apertures 217 for receiving the incubation lid 220, such that the apertures 217 have sizes and shapes that substantially match the incubation lid 220.

To enhance positional accuracy and repeatability, the apparatus 200 also may include one or more positional sensors (e.g., encoders) 276 configured to measure and track the position of the movable stage 210, including to assist in properly aligning the substrate 204 with the dispensing elements 252 in the dispensing region 207 and/or with the incubation lid 220 in the incubating region 209. A few examples of possible locations of such positional sensors 596 are illustrated in FIGS. 2A and 2B. The use of positional sensors 276 in cooperation with movable components of a system such as the illustrated apparatus 200 are generally understood by persons skilled in the art. Such positional sensors 276 may be utilized, for example, to measure the position of the substrate 204 with reference to a coordinate system (e.g., considering one or more X-, Y-, Z-, θ-axes), determine whether the substrate position has changed (deviated) in comparison to the previous iteration of the same operational step, calibrate a component responsible for moving or adjusting the substrate position, etc. Generally, positional sensors are appreciated by persons skilled in the art, and often are optics-based devices. For example, a positional sensor may include a light source (e.g., a laser, laser diode (LD), light-emitting diode (LED), etc.) and a light detector (e.g., a photodiode (PD), photomultiplier tube (PMT), etc.), or additionally other optical components, (e.g., a lens, mirror, etc.). Optionally, these positional sensors may detect features on the substrate 204 such as fiducials, features on the substrate holder 211, or encoder positions. In addition, one or more of the positional sensors 276 may be positioned to direct a light beam into intersection with the paths of liquid droplets dispensed by the dispensing elements 252, thus enabling the detection of misfiring by one or more of the dispensing elements 252 (e.g., due to clogging or hardware/circuitry malfunction).

In some implementations, the incubation lid is partially or entirely transparent so that the droplet size or other conditions in the incubation volume conditions can be monitored during heating and/or incubation. For instance, the incubation lid can comprise a window or other transparent portion in a lid ceiling and/or a lid wall. In some implementations, the substrate stage and/or substrate holder is partially or entirely transparent so that the droplet size or other conditions in the incubation volume conditions can be monitored during heating and/or incubation. In some implementations of the present methods, droplet size or other conditions are assessed, and temperature ramp rate, temperature or additional vapor conditions are adjusted based on the assessment.

The apparatus 200 for biopolymer synthesis 200 also may include a system controller (or controller, or computing device) 280. The system controller 280 may schematically represent one or more modules (or units, or components) configured for controlling, monitoring and/or timing various functional aspects of the apparatus 200 including, for example, the operations of the liquid dispensing device 250, the staging assembly 260, the incubation lid 220, and other instruments or devices located at various stations (e.g., 262). For all such purposes, the system controller 280 may be in signal (wired or wireless) communication with one or more of the components of the apparatus 200, as depicted by dashed lines in FIGS. 2A and 2B. More particularly, the controller 280 can be in signal communication with one or more of the incubation lid 220, the incubation lid actuator 221, the dispensing device 250, the staging assembly 260, positional sensors 276, fluid flow devices (e.g., pumps) for providing fluids to the incubation lid 220 or the dispensing device 250, and/or other components. The controller 280 can include any suitable combination of hardware, firmware, software, etc., including one or more electronics-based processors and memories, as appreciated by persons skilled in the art. For example, the system controller 280 may include a non-transitory (or tangible) computer-readable medium that includes non-transitory instructions for performing any of the methods disclosed herein.

The apparatus 200 for biopolymer synthesis also may include a deck (or table, bench, optical bench, platform, base, etc., not shown) on which the components described above are supported. Such components may be fixed or attached to the deck or may simply rest on the deck. The deck may be configured to suppress vibrations. Depending on the implementation, the deck may be considered to be part of or separate from the apparatus 200. In addition, all or part of the apparatus 200 may be enclosed by an appropriate enclosure, which may be transparent and/or gas-tight to maintain a controlled (e.g., humid,.) operating environment. The apparatus 200 may include a system for introducing humidity into the interior of the enclosure in the enclosed interior space if needed for a given application.

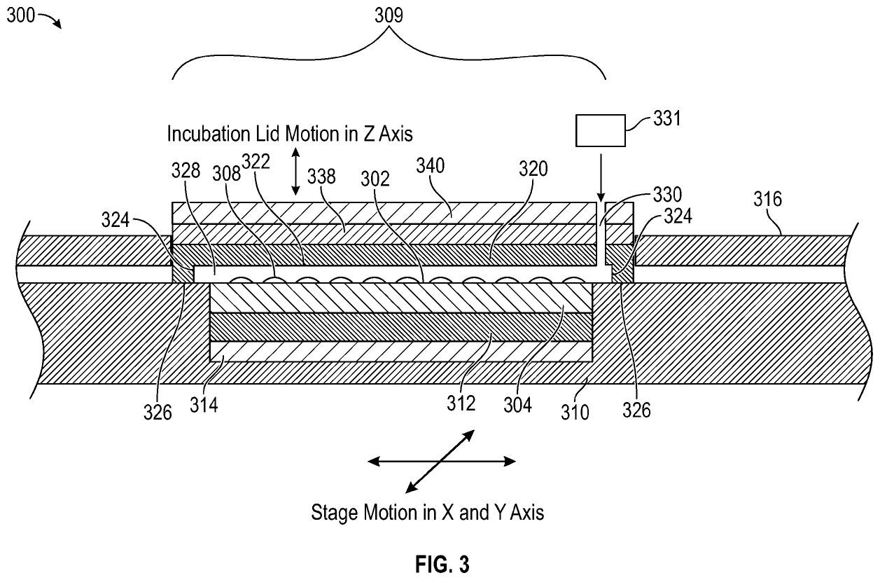

As a further example of the present methods and apparatus, FIG. 3 is an elevational view of an apparatus 300 for incubating droplets. Apparatus 300 contains a substrate 304 in an incubating region 309. Substrate 304 has had spots 308 (droplets) dispensed onto its top surface 302. In some embodiments droplets 308 have been dispensed in a dispensing region as shown in FIG. 2A; in other embodiments, droplets 308 have been dispensed in other ways prior to movement of the substrate 304 into the incubating region 309. The apparatus comprises a substrate stage 310 for moving the substrate 304 from a dispensing region to the incubating region 309 (as illustrated in FIG. 2B). Substrate stage 310 comprises a cavity configured to hold the substrate 304, but it is also contemplated that a substrate holder may be included in some implementations. The apparatus 300 also includes an incubation lid 320 for forming an incubation chamber or incubating region that substantially encloses droplets 308. Incubation lid 320 is in a closed position, having been moved through an aperture in evaporation cover 316. The apparatus 300 can also comprise a lid actuator, such as for moving incubation lid 320 in a Z-axis and/or a stage actuator for moving substrate stage 310 in an X-axis and/or Y-axis (as described above).

The incubation lid 320 comprises an incubation lid ceiling 322 and at least one incubation lid wall 324 form an incubation chamber 328 having an incubation volume. The at least one lid wall 324 can be one lid wall that is circular or oval in shape, or it can be several lid walls that connect to form a rectangular area or an area of other shape. In some implementations, the incubation lid wall(s) 324 extends from about 100 to about 1000 micrometers from the incubation lid ceiling 322, or from about 200 to about 300 micrometers the incubation lid ceiling 322. In some implementations, the incubation lid wall(s) 324 comprise incubation lid wall ends 326 which are distal from the incubation lid ceiling 322. The incubation lid wall ends 326 can be configured to contact the substrate stage 310 and/or the substrate 304 held by the stage 310. The incubation lid wall ends 326 can be configured to form a fluid-tight seal with the substrate stage 310 and/or with the substrate 304 held by the substrate stage 310. When the incubation lid 320 is in a closed position, an incubation chamber 328 is defined by the incubation lid ceiling 322, the incubation lid walls 324, the top surface 302 of the substrate 304, and surfaces of the substrate stage 310 adjacent to the substrate 304.

The substrate stage 310 can comprise one or more thermal elements for increasing and/or decreasing the temperature of the substrate, thereby increasing and/or decreasing the temperatures of the droplets and/or the incubation volume. The thermal elements can provide heating and/or cooling as desired for incubation of the droplets 308 and in a controlled manner. For example, the substrate stage 310 of FIG. 3 comprises two thermal elements: a substrate heating element 312 and a substrate cooling element 314. The substrate heating element 312 heats to the substrate 304 to a desired temperature and/or for a desired period, such as for one or more steps or reactions during an incubation period or a portion thereof. Exemplary heating elements include a resistive heating element, such as a cartridge heater, wire heater or a foil heater, a Peltier element, a microwave element or a channel or other flowpath through the substrate stage 310 or a portion thereof, so that a heated fluid can flow through the substrate state to provide an efficient heating of the substrate. The substrate heating element 312 can directly contact the substrate 304 held by the substrate stage 310, or it can indirectly heat the substrate through an intervening layer that contacts the substrate. Suitable intervening layers can be prepared from materials having high thermal conductivity, a low thermal mass and/or that are electrically insulating.

The substrate stage 310 also comprises a substrate cooling element 314 that cools the substrate 304 to a desired temperature and/or for a desired period, such as after one or more steps or reactions. In some embodiments, the substrate cooling element 314 reduces the temperature of or withdraw heat from the substrate during a portion of an incubation period or after an incubation period ends. Exemplary cooling elements include a channel or other flowpath through the substrate stage 310 or a portion thereof, so that a heat exchange fluid can flow through the substrate state to provide an efficient cooling of the substrate, thereby cooling the droplets on the substrate. In some embodiments, the heat exchange fluid is air, water, or a coolant liquid. Another exemplary cooling element is a Peltier element or other thermally conductive material. While the implementation shown in FIG. 3 has one substrate heating element and one substrate cooling element, it is contemplated that heating and cooling can both be performed by a single substrate thermal element, or that a plurality of substrate heating elements and/or a plurality of substrate cooling elements can be included in the substrate stage 310.

The incubation lid 320 can comprise one or more lid thermal elements. For example, lid 320 comprises a lid heating element 338 that heats the incubation volume, such as during an incubation period. Suitable lid heating elements include the heating elements described with regard to the stage heating elements 312. The incubation lid can comprise one or more lid cooling elements 340 that reduce the temperature of the incubation volume after the incubation period. Suitable lid cooling elements 340 include the cooling elements described with regard to the stage cooling elements 314. While the implementation shown in FIG. 3 has one lid heating element and one lid cooling element, it is contemplated that heating and cooling can both be performed by a single lid thermal element, or that a plurality of substrate heating elements and/or a plurality of substrate cooling elements can be included in the incubation lid 320.

In the implementation shown in FIG. 3, the incubation lid 320 further comprises an incubation lid flow path 330 from the exterior of the incubation chamber 328 to its interior. The incubation lid flow path 330 can be used to provide one or more fluids to the incubation chamber 328 when the incubation lid 320 is in a closed position. In some implementations, vapor is added and/or removed to the incubation chamber 328 through the incubation lid flow path 330. Additional sources of vapor can be provided for example by fluidically connecting the incubation lid flow path 330 to a vapor source 331 or reservoir. Vapor can be removed by fluidically connecting the incubation lid flow path 330 to a vacuum source or a pump. After incubation at elevated temperature is complete, the incubation lid and substrate can be cooled back to the desired temperature for subsequent steps.

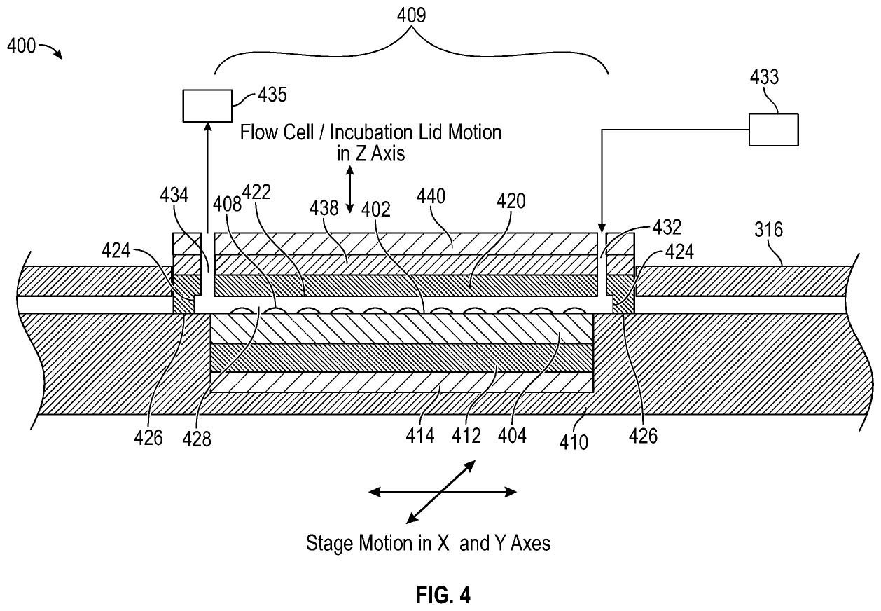

FIG. 4 is an elevation view of another example of an incubation chamber, according to an implementation of the present disclosure. Like the implementation of FIG. 3, apparatus 400 holds a substrate 404 having a top surface 402 with droplets 408 dispensed thereon. Apparatus 400 comprises a substrate stage 410, which comprises a substrate heating element 412 and a substrate cooling element 414. Apparatus 400 also comprises an incubation lid 420 which comprises an incubation lid ceiling 422, at least one incubation lid wall 424, which has incubation lid wall end(s) 426. The incubation lid 420, the substrate 404 and the surface of the stage 410 form an incubation chamber 428 having an incubation volume. The incubation lid 420 is in a closed position, having been moved through an aperture in evaporation cover 416. The incubation lid 420 comprises a lid heating element 438 and a lid cooling element 440. The apparatus 400 can also comprise a lid actuator, such as for moving incubation lid 420 in a Z-axis and/or a stage actuator for moving substrate stage 410 in an X-axis and/or Y-axis (as described above).

In the apparatus 400 for incubating droplets shown in FIG. 4, the incubation lid 420 comprises an incubation lid fluid inlet 432 and an incubation lid fluid outlet 434. The incubation lid fluid inlet 432 can be employed to flow a reagent fluid, wash fluid or purge fluid into incubation chamber 428. The incubation lid fluid inlet 432 can be fluidically connected to one or more reservoirs 433, such as a reagent fluid reservoir, a wash fluid reservoir, a purge fluid reservoir or other reservoir. The incubation lid fluid outlet 434 can be employed to remove the reagent fluid or wash fluid out of incubation chamber 428. Reagent fluids can comprise one or more of the reagents described above. Wash fluids can be used to remove reagents and other components from the substrate, such as after a desired reaction has occurred. Wash fluids can comprise water and/or organic solvents. Purge fluids can comprise a purge gas such as nitrogen, argon or other inert gas. The incubation lid fluid outlet 434 can be fluidically connected to a waste fluid reservoir 435 or other reservoir. Although one fluid inlet and one fluid outlet are shown, it is also contemplated that an incubation lid can comprising two fluid inlets and two fluid outlets, or two or more fluid inlets and a single fluid outlet, or any desired number or combination of fluid inlets and fluid outlets.

As illustrated, the incubation chamber 328/428 may be defined or bounded at least in part by a top surface 302/402 of the substrate 304/404 and the incubation lid 320/420 positioned above the substrate 304/404. In some embodiments, one or more lid wall 324/424 contact or are sufficiently close to the substrate 304/404 or substrate stage 310/410 to form an essentially closed chamber. The interior of the incubation chamber 328/428 creates an incubation volume defined by at least in part by a vertical gap G, between the top surface 302 of the substrate 304 and the ceiling 322/422 of the incubation lid 320/420. The gap G may be minimized to create a small enclosed incubation volume in which the droplets reside. With this small enclosed volume, as the droplets evaporate, the evaporation rate of the droplets can come to equilibrium with the condensation rate, though the equilibrium will be disrupted if the temperature in the incubation volume is adjusted. Accordingly it may be desirable to add and/or remove vapor to the incubation volume during the heating. Vapor can be added or removed in an amount and/or rate sufficient to maintain the droplets in size or concentration during the incubation period.

The gap G of the incubation lid ceiling 322/422 above top surface 302/402 may be adjusted as needed for a given application. The magnitude of the gap G can depend on the application, including the volume of the dispensed droplets 308/408. For many applications, the gap G may be on the order of micrometers (i.e., between one or a few μm to 1000 μm). As one example, the gap G may be in a range from 200 μm to 400 μm. In some implementations, the incubation volume is substantially enclosed on all sides (e.g., including the lateral sides 320/420) by providing lid wall ends 326/426 that form a fluid-tight seal with the substrate stage 310/410 or the substrate itself.

The substrate stage 310/410 can move the substrate 304/404 relative to the incubation lid 320/420 along one or more axes. A double arrow in FIGS. 3 and 4 represents movability of the substrate 304 along one horizontal axis (e.g., X-axis or Y-axis). Movement of the substrate 304 from an external position outside the incubation chamber 328/428 to an internal (or operating) position directly under the incubation lid 320/420, as shown in FIGS. 3 and 4, forms the incubation chamber 328/428. As examples, from the perspective of FIGS. 3 and 4, the substrate 304/404 may be moved (e.g., linearly translated) from the left or right toward the incubation chamber 328/428 to be formed, and/or from the front or the back (i.e., in a direction into or out from the plane of the drawing sheet) toward the incubation chamber 328/428 to be formed.

In the present apparatus and methods, various tasks may be performed in the incubation chamber 328/428, including but not limited to reactions and steps for biopolymer synthesis. For example, the substrate 304/404 may be heated or cooled, and one or more synthesis reactions can occur at an increased or decreased temperature. The substrate also may be washed or contacted by reagents or other solutions prior to and/or after the incubation, and/or between multiple iterations of incubation. As another example, after one or more incubating steps have been carried out, the spots 308/408 containing material from the droplets may be measured, analyzed, or imaged by an appropriate instrument, again while the substrate 304/404 is positioned outside the incubation chamber 328/428.

In the example illustrated in FIGS. 3 and 4, a single substrate 304/404 is shown. It is also contemplated, however, that an incubation chamber can encompass more than one substrate 304/404, and/or that an apparatus can comprise more than one distinct incubation chamber.

The incubation lid 320/420 can be formed from any material suitable for the incubation conditions. In some implementations, the incubation lid 320/420 is made of a transparent material to enable the droplets and array of spots 308/408 to be observed, optionally with the aid of a camera or the like.

The substrate stage 310/410 is configured to hold the substrate 304/404 (or more than one substrate) in a secure and repeatable position on or in the top side of the substrate stage. For this purpose, the substrate stage 310/410 may include appropriate mechanical mounting features (e.g., clamps, pins, etc.). Alternatively or additionally, the substrate stage 310/410 may be or include a vacuum chuck configured to hold the substrate 304/404 by application of a vacuum at the underside of the substrate 304/404. In the latter case, the substrate stage 310/410 communicates with a suitable vacuum source such as a vacuum pump of any suitable type (not shown).

A fluid-tight seal can be formed by an incubation lid (more particularly, by a portion of the incubation lid such as an incubation lid wall end, or by another structure attached to the incubation lid) in contact with a substrate or substrate stage. The incubation lid and the top of a substrate form an incubation chamber. A fluid-tight seal can be formed inside the perimeter of the substrate, and an incubation lid wall can be used to form the outer wall(s) which extends between the top surface of the substrate and the incubation chamber ceiling. In some embodiments, the incubation lid comprises a seal such as an O-ring or an over-molded elastomer on the surface of the incubation lid. O-rings and over-molded elastomers generally require significant compressive forces to form a leak proof seal, typically on the order of 75 lbs for a 75 mm square glass substrate. Such forces require a machine design that can support this load as well as vertical motion to provide clearance for moving a glass substrate into and out of the incubation chamber. Because these sealing techniques are stiff, they have to be sized and designed for a specific chamber height.

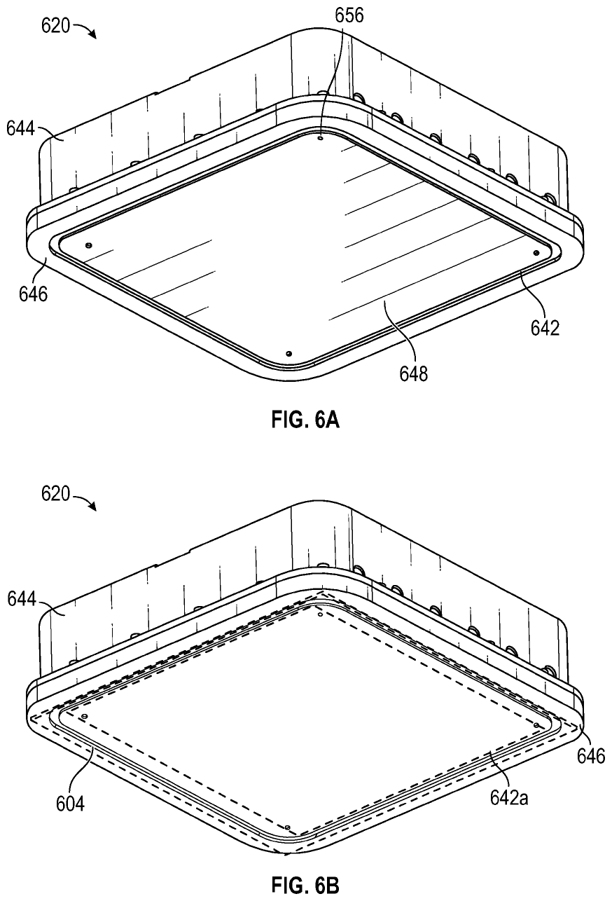

As another aspect of the present disclosure, an incubation lid comprises an inflatable seal. FIGS. 6A and 6B show a perspective view of another embodiment of an incubation lid 620 with an inflatable seal 642. The incubation lid 620 comprises a clamp body 644, a rim body 646, and a main block 648. The clamp body 644 and a rim body 646 support the inflatable seal 642 and provide a conduit for inflation. The main block 648 provides the incubation lid ceiling. FIG. 6B shows the incubation lid 620 positioned over a glass substrate 604. The inflated seal 642a fits within the perimeter of the glass substrate 604 and is located close to the four outer edges of the substrate 604. The glass substrate 604 is supported on its underside by a substrate stage, such as vacuum chuck (not shown). The vacuum chuck maintains the position of the glass substrate relative to the incubation lid 620.

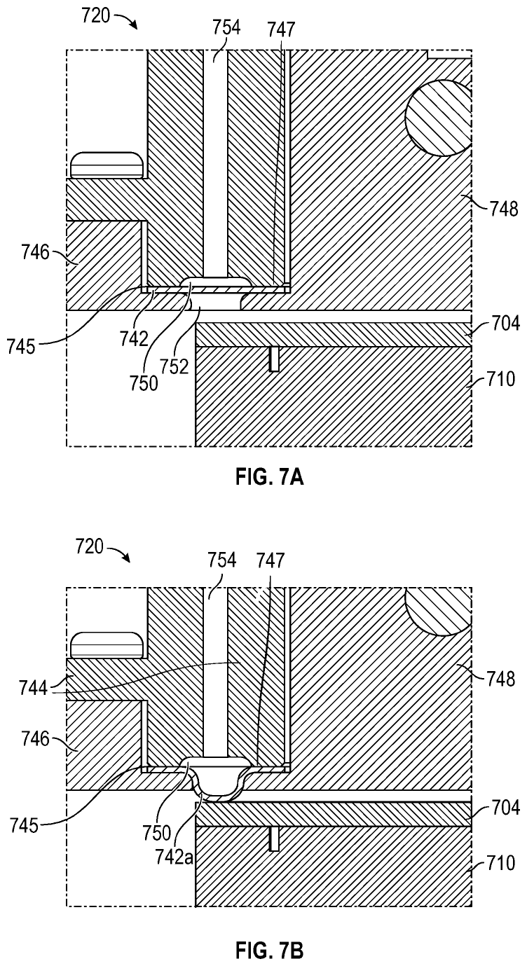

FIGS. 7A and 7B show a side view of an incubation lid 720 with an inflatable seal 742. FIG. 7A shows a cross sectional side view of the incubation lid 720, glass substrate 704 and supporting substrate stage 710 (e.g., a vacuum chuck). In an exemplary embodiment, the inflatable seal 742 is a thin (e.g., 0.25 mm thickness) elastomer, typically silicone which can be repeatably expanded under force and stretched up to 5× its relaxed size. The incubation lid 720 comprises a clamp body 744, a rim body 746, and a main block 748. The inflatable seal 742 is clamped into position at 2 clamp lines 745 and 747 that run along the inner and outer edges. The outer edge clamp is between the rim body 746 and clamp body 744. The inner edge clamp 747 is between the main block 748 and clamp body 744. A slot 750 milled into the clamp body 744 just above the flexible seal 742 creates a sealed cavity that can be pressurized via the cavity pressure port 754 in the clamp body 744. Pressurizing this cavity forces the inflated seal (see 742a in FIG. 7B) to expand into an aperture 752 adapted for receiving the inflated seal, and the inflated seal eventually contacts the top surface of the glass substrate 704 and forms a fluid-tight seal. Upon relieving the pressure in the cavity 750, the inflatable seal 742 contracts back into its original relaxed shape as shown in FIG. 7A.

In some embodiments, the apparatus comprises an incubation lid with inflatable seal made from medical grade silicone. The inherent flexibility of silicone makes it possible to operate over many cycles and varied chamber heights. The aqueous chemicals used in enzymatic oligonucleotide synthesis are compatible with silicone. There are other synthesis processes which use chemicals that are not compatible with silicone. Such processes require a more robust seal material for the incubation lid, such as a perfluoroelastomer such as Kalrez® (available from DuPont). Although an elastomer, Kalrez is too stiff to function as the inflatable seal described above. However, one can design a seal architecture that uses the inflatable seal approach described above as an actuator in conjunction with a stiff perfluoroelastomer layer to isolate the silicone from incompatible chemicals.

In some embodiments, the incubation chamber volume can have a shape resembling a very thin box relative to its side dimensions. Almost all of the surface area of the incubation chamber are the top and bottom faces, main block and substrate surfaces respectively. The area of these surfaces can be about 9.2 square inches, for example. During operation fluids can be moved into and out of the incubation chamber via access ports 656 in the main block. These holes are visible in FIG. 6A. Pressure in the incubation chamber to move these fluids is typically under 1 psia but could be as high as 5 psia in the event of a failure. The inflatable seal is fluid-tight with a chamber pressure of 5 psia. During operation the apparatus can experience temperature cycles between about 22 and 80° C., and the inflatable seal can be adapted for operation in such temperature cycles.

Among the advantages of the inflatable seal over O-rings and over-molded seals is that it can accommodate a broader range of chamber heights. Tradition seals tend to be stiff and operate at a fixed height such as 500 μm. An inflatable seal can accommodate chamber heights of 0 to 2000 μm. Such a range gives better process development flexibility. The shape of the chamber volume can also be varied. A wedge-shaped variation in height between opposing edges will aide in draining fluid which is desirable for accurate process control. As an example, the incubation lid can be oriented such that one edge is at 200 μm from the top surface of a glass substrate and the opposing edge 500 μm. This wedge shape has been shown to aide fill and drainage by maintaining a consistent fluid boundary (line) forcing the fluid to drain from the higher side to the lower side, leaving less isolated regions of fluid behind.

Another advantage is low contact force for sealing. With a cavity pressure of 20 psi the force exerted on the glass substrate is less than 10 lbs, significantly less than the typical 75 lbs required for traditional seals. This means the physical structure for operating the incubation chamber apparatus can be simpler. Any angular misalignment between a glass substrate and incubation lid, intentional or not, can be accommodated without sacrificing seal integrity.

Another advantage is no vertical motion required for the glass substrate load and unload. Traditional seal techniques require a lid to be translated upward to provide vertical clearance for the glass substrate to be indexed into and out of the chamber. Once a glass substrate is positioned below the incubation lid, the incubation lid must be translated downward and force applied to properly seal to the top surface. of the glass. The mechanism to do this adds complexity to the overall design resulting in more maintenance and process reliability issues. In the case of the inflatable seal, the pressurized expansion takes care of this motion.

As another aspect of the present disclosure, methods are provided for incubating droplets. The method comprises dispensing droplets onto a top surface of a substrate while the substrate is positioned in a dispensing region; moving the substrate to an incubating region; forming a substantially enclosed incubation volume for the droplets; and incubating the droplets in the incubation volume. In some implementations, wherein the droplets comprise one or more of reagents for biopolymer synthesis, the incubation is for one or more reactions or steps of a biopolymer synthesis process, such as the addition of a nucleotide to an oligonucleotide. The incubation volume can be formed by positioning an incubation lid (including but not limited to incubation lids 320/420 described above) over the droplets. A ceiling of the incubation lid and the top surface of the substrate define a gap, which may be from 1 to 1000 micrometers, depending on the desired incubation volume. In some embodiment, the incubation volume is defined by dimensions of the top surface of the substrate, for example 75 mm to 150 mm square, and a height over the top surface of the substrate ranging, for example, between 300 to 500 μm.

The incubating step can comprise adjusting a temperature of the incubation volume, the droplets, and/or the substrate. For instance, the temperature can be increased to an incubation temperature (such as for an incubation period or a portion thereof). In some embodiments, the method comprises adding vapor to the incubation volume during the heating, such as water vapor when the droplets are aqueous droplets or propylene carbonate vapor when the droplets comprise propylene carbonate. In general, the vapor added to the incubation volume can comprise a solvent present in the droplets, which can be desirable when the solvent has a high vapor pressure. In some embodiments, the method comprises removing vapor from the incubation volume during the heating. The vapor can be added or removed in an amount and/or rate sufficient to maintain the droplets in size or concentration during the incubation period. Exemplary droplet volumes are from 1 to 100 picoliters. Such droplets can be dispensed on the substrate by any suitable technique, such as by dispensing from a liquid dispensing device such as a printer. In some implementations, the method comprises cooling the droplets after an incubation period or a portion thereof.

In the present methods, incubating the droplets can initiate and/or promote an interaction between two or more components. At least one of the two or more components is initially part of the droplets, or initially part of spots present on the top surface prior to the dispensing and on which the droplets are dispensed.

In general, the steps for enzymatic oligo library synthesis (eOLS) include attaching a starter oligo sequence to a surface, depositing small droplets (e.g., 1-50 pL) of the desired nucleotide at known locations on the substrate, depositing small droplets (e.g., 1-50 pL) of TdT at all locations which received any type of nucleotide, providing appropriate conditions for the enzyme to attach the nucleotide to the oligonucleotides on the surface covered by that liquid, removing the liquid when the reaction is completed, deblocking the added nucleotide to prepare for the next cycle, drying the surface and repeating the process for the next nucleotide addition.

When the present methods are used for enzymatic oligonucleotide synthesis, the droplets (e.g., first droplets) may comprise a nucleotide triphosphate or a degenerate nucleotide. Such methods can also comprise dispensing second droplets into contact with the respective first droplets on the top surface. The second droplets can comprise an enzyme such as engineered versions of terminal deoxynucleotidyl transferase (TdT) or other polymerases. The method can then comprise moving the substrate to an incubation region for an incubating step. After an incubation period, which may include a wash step, the method can further comprise dispensing third droplets into contact with respective spots on the top surface comprising, or which previously comprised (before washing), the first droplets and the second droplets. The third droplets can comprise a deblocking reagent. The substrate can be moved to an incubation region for an incubation period. The method can comprise repeating the steps of dispensing the first droplets, the second droplets, and the third droplets, with intervening incubating steps, until oligonucleotides of desired lengths are synthesized on the spots. Alternatively, the method can comprise depositing the first and second droplets, moving the substrate to the incubation chamber for the incubation step, washing the substrate within the incubation chamber and removing the fluid, introducing a deblocking reagent within the incubation chamber and removing the fluid, allowing the substrate to dry and repeating the steps of dispensing droplets, incubating, and adding wash and deblocking fluids until oligonucleotides of desired lengths are synthesized on the spots.

### EXEMPLARY EMBODIMENTS

Exemplary embodiments provided in accordance with the presently disclosed subject matter include, but are not limited to, the following:

Embodiment 1. An apparatus for incubating droplets on a surface of a substrate, said apparatus comprising (a) a substrate stage for moving the substrate from a dispensing region to an incubating region; (b) a liquid dispensing device in the dispensing region comprising a plurality of dispensing elements for dispensing droplets; and (c) an incubation lid in the incubating region configured for moving between open and closed positions with respect to the substrate, wherein the incubation lid and the substrate form an incubation chamber when the incubation lid is in a closed position.

Embodiment 2. The apparatus of embodiment 1, further comprising one or more thermal elements for increasing and/or decreasing a temperature of the substrate and/or the incubation chamber.

Embodiment 3. The apparatus of embodiment 1 or embodiment 2, further comprising a lid actuator for moving the incubation lid in a Z-direction; and a stage actuator for moving the substrate stage in an X-direction and/or a Y-direction.

Embodiment 4. The apparatus of any of embodiments 1 to 3, wherein the substrate stage comprises a cavity configured to hold the substrate.

Embodiment 5. The apparatus of any of embodiments 1 to 3, further comprising a substrate holder for holding the substrate, wherein the substrate holder is attached to or integral with the substrate stage.

Embodiment 6. The apparatus of any of the foregoing embodiments, wherein the substrate stage comprises a substrate thermal element.

Embodiment 7. The apparatus of embodiment 6, wherein the substrate thermal element comprises a substrate heating element that contacts a surface of the substrate.

Embodiment 8. The apparatus of embodiment 6, wherein the substrate thermal element comprises a substrate cooling element.

Embodiment 9. The apparatus of any of the foregoing embodiments, wherein the incubation lid comprises an incubation lid thermal element.

Embodiment 10. The apparatus of embodiment 9, wherein the incubation lid thermal element comprises an incubation lid heating element, such as a resistive heating element embedded in the incubation lid.

Embodiment 11. The apparatus of embodiment 9, wherein the incubation lid thermal element comprises an incubation cooling element, such as a heat exchange element through which a cooling fluid can flow.

Embodiment 12. The apparatus of any of the foregoing embodiments, further comprising an evaporation cover that creates a head space in a dispensing region and/or between the dispensing region and the incubating region.

Embodiment 13. The apparatus of embodiment 12, wherein the evaporation cover comprises one or more apertures for receiving the incubation lid, such that the apertures correspond to the incubating regions.

Embodiment 14. The apparatus of any of the foregoing embodiments, wherein the incubation lid comprises a lid ceiling and at least one lid wall that define an incubation chamber.

Embodiment 15. The apparatus of embodiment 14, wherein the at least one lid wall extends from about 100 to about 1000 micrometers from the incubation lid ceiling.

Embodiment 16. The apparatus of embodiment 14, wherein the at least one lid wall extends from about 200 to about 300 micrometers.

Embodiment 17. The apparatus of any of the foregoing embodiments, wherein the incubation lid comprises one or more flow paths to the incubation chamber, such as a vapor flow path.

Embodiment 18. The apparatus of any of the foregoing embodiments, wherein the incubation lid comprises a fluid inlet and a fluid outlet.

Embodiment 19. The apparatus of embodiment 18, wherein the fluid inlet is fluidically connected to a reservoir.

Embodiment 20. The apparatus of embodiment 19, wherein the reservoir is a reagent reservoir.

Embodiment 21. The apparatus of embodiment 19, wherein the reservoir is a wash fluid reservoir.

Embodiment 22. The apparatus of embodiment 19, wherein the reservoir is a purge fluid reservoir.

Embodiment 23. The apparatus of embodiment 14, wherein the at least one lid wall comprises a lid end distal from the incubation lid ceiling, wherein the incubation lid end is configured to contact the substrate stage or the substrate held by the stage.

Embodiment 24. The apparatus of embodiment 23, wherein the incubation lid end is configured to form a fluid-tight seal with the substrate stage and/or with the substrate held by the substrate stage.

Embodiment 25. The apparatus of any of the foregoing embodiments, wherein the incubation lid comprises an inflatable seal configured to contact the substrate stage and/or the substrate held by the substrate stage.

Embodiment 26. The apparatus of any of the foregoing embodiments, wherein the incubation lid is partially or entirely transparent.

Embodiment 27. The apparatus of any of the foregoing embodiments, further comprising a controller in signal communication with the substrate stage or with a stage actuator for moving the substrate stage in an X-direction and/or a Y-direction.

Embodiment 28. The apparatus of embodiment 27, further comprising one or more positional sensors for sensing a position of the substrate stage, wherein the one or more positional sensors are in signal communication with the controller.

Embodiment 29. The apparatus of any of the foregoing embodiments, further comprising a controller in signal communication with the incubation lid or with a lid actuator for moving the incubation lid in a Z-direction.

Embodiment 30. A method for incubating droplets, the method comprising dispensing droplets onto a top surface of a substrate while the substrate is positioned in a dispensing region;

moving the substrate to an incubating region; forming an incubation volume that substantially encloses the droplets; and incubating the droplets in the incubation volume.

Embodiment 31. The method of embodiment 30, wherein the incubating step comprises adjusting a temperature of the incubation volume, the droplets, and/or the substrate.

Embodiment 32. The method of embodiment 31, wherein the temperature is increased to an incubation temperature for an incubation period or a portion thereof.

Embodiment 33. The method of any of embodiments 30 to 32, further comprising adding vapor to the incubation volume during the heating.

Embodiment 34. The method of any of embodiments 30 to 33, further comprising removing vapor from the incubation volume during the heating.

Embodiment 35. The method of embodiment 32 or 33, where the vapor is added or removed in an amount and/or rate sufficient to maintain the droplets in size or concentration during the incubation period.

Embodiment 36. The method of any of embodiments 30 to 35, further comprising cooling the incubation volume, the droplets, and/or the substrate after an incubation period or during a portion of an incubation period.

Embodiment 37. The method of any of embodiments 30 to 35, wherein the droplets comprise water.

Embodiment 38. The method of any of embodiments 30 to 37, wherein the incubation volume is formed by positioning an incubation lid over the droplets.

Embodiment 39. The method of embodiment 38, further comprising forming a fluid-tight seal between the incubation lid and the substrate and/or a substrate stage holding the substrate.

Embodiment 40. The method of embodiment 39, wherein the incubation lid comprises an inflatable seal, and the fluid-tight seal is formed by inflating the inflatable seal to contact the substrate and/or the substrate stage.

Embodiment 41. The method of any of embodiments 38 to 40, wherein the top surface and a ceiling of the incubation lid define a gap of the incubation volume, and the height is from 1 to 1000 micrometers.

Embodiment 42. The method of any of embodiments 30 to 41, further comprising assessing droplet size or other conditions in the incubation volume, and adjusting a temperature ramp rate, a temperature, or a vapor content based on the assessment.

Embodiment 43. The method of any of embodiments 30 to 42, wherein the droplets each have a volume from 1 to 100 picoliters.

Embodiment 44. The method of any of embodiments 30 to 43, wherein the droplets are dispensed from a liquid dispensing device.

Embodiment 45. The method of embodiment 44, wherein the liquid dispensing device is a printer.

Embodiment 46. The method of any of embodiments 30 to 45, wherein the incubating of the droplets initiates and/or promotes an interaction between two or more components, and at least one of the two or more components is initially part of the droplets, or initially part of spots present on the top surface prior to the dispensing and on which the droplets are dispensed.

Embodiment 47. The method of any of embodiments 30 to 46, wherein the droplets comprise one or more reagents for biopolymer synthesis.

Embodiment 48. The method of embodiment 47, further comprising introducing one or more fluids to the incubation volume to the synthesized biopolymer.

Embodiment 49. The method of any of embodiments 30 to 46, wherein the droplets comprise one or more reagents for oligonucleotide synthesis.

Embodiment 50. The method of embodiment 49, wherein the droplets comprise a nucleotide triphosphate or a degenerate nucleotide.

Embodiment 51. The method of embodiment 50, wherein the droplets comprising the nucleotide triphosphate or the degenerate nucleotide are first droplets, and the method further comprises dispensing second droplets into contact with the respective first droplets on the top surface.

Embodiment 52. The method of embodiment 51, wherein the second droplets comprise an enzyme.

Embodiment 53. The method of embodiment 49, wherein the droplets comprise an enzyme.

Embodiment 54. The method of embodiment 53, wherein the droplets comprising the enzyme are first droplets, and the method further comprises dispensing second droplets into contact with the respective first droplets on the top surface.

Embodiment 55. The method of embodiment 54, wherein the second droplets comprise a nucleotide triphosphate or a degenerate nucleotide.

Embodiment 56. The method of any of embodiments 51, 52, 54 or 55, further comprising dispensing third droplets into contact with respective spots on the top surface comprising, or which previously comprised, the first droplets and the second droplets.

Embodiment 57. The method of embodiment 56, wherein the third droplets comprise a deblocking reagent.

Embodiment 58. The method of embodiment 56, comprising the repeating the steps of dispensing the first droplets, the second droplets, and the third droplets until oligonucleotides of desired lengths are synthesized on the spots.

Embodiment 59. The method of any of embodiments 30 to 58, further comprising introducing one or more fluids to the incubation volume to wash the substrate.

### EXAMPLES

### Example 1

In this experiment, the incubation of droplets in an incubation chamber was evaluated by imaging. The incubation chamber had the general design illustrated in FIG. 3 above. Water droplets were dispensed on a top surface of a glass substrate. The glass substrate was enclosed inside an incubation chamber, forming an incubation volume that substantially enclosed the droplets.

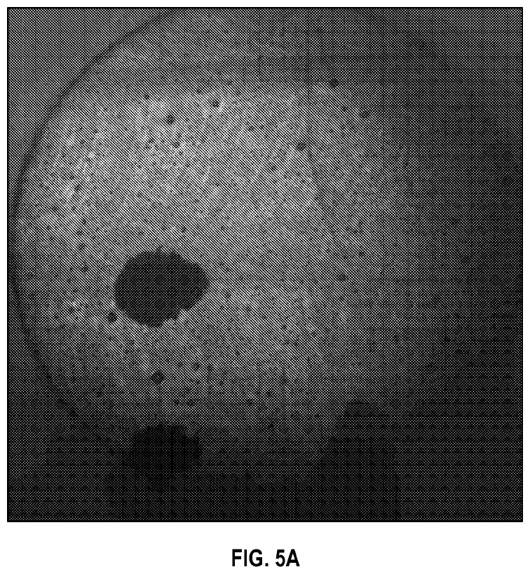

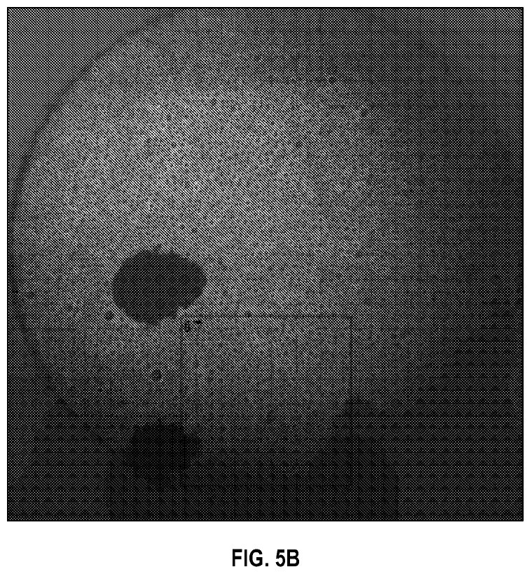

FIGS. 5A and 5B are images of the substrate taken from below, through a window in the substrate holder and through the glass substrate. Accordingly, the images look through substrate stage 310, substrate cooling element 314, substrate heating element 312 and substrate 304 as illustrated in FIG. 3. FIG. 5A is an image when the incubation chamber was at room temperature (about 25 C). For reference, the circled droplet in FIG. 5A is ~40 microns in diameter, which would correspond to a ~17 picolitre hemispherical droplet, though the true shape or contact angle is not known with certainty.

The temperatures of the incubation chamber and substrate heater were adjusted to 80° C., and FIG. 5B is an image of the substrate captured 14 minutes later. FIG. 5B shows that the water droplets remained on the substrate, even after a significant incubation period. In contrast, water droplets of the same size evaporate in seconds when the glass surface is outside an incubation chamber (that is, at room temperature and when exposed to ambient conditions).

### Example 2

In this experiment, a prototype of an incubation lid having an inflatable seal was built and tested. The seal was 2 mm wide about 10 mm inside the outer edges. The region surrounded by the seal is the incubation chamber. For test purposes a 6 mm thick sheet of clear Acrylic, which simulates the glass substrate, was screwed in place with 500 μm thick shims (yellow pieces) to achieve the actual chamber height. A chamber pressure port in the middle of the chamber region was for pressurizing the chamber during testing.

A cavity port was plumbed to a switchable regulated pressure source for operating the inflatable seal. A regulated worst-case pressure of 5 psi was applied to the chamber port during testing. Practice has revealed that a cavity pressure of 20 psi is sufficient for sealing a chamber pressure of 5 psi. This was verified by placing the assembly in water and examining for leaks (bubbles) when the inflatable seal is pressurized.

For cycle testing the inflatable seal was expanded (pressurized) and relaxed (vented to atmosphere) with a 4 second interval. A complete cycle took 8 seconds. The cycling was performed with the assembly submerged in water. The 4 second sealed interval was enough time to observe any leakage of air from the cavity beyond the outline of the inflatable seal. 100,000 cycles were performed with no noticeable seal wear or fatigue. Chamber seal integrity also remained intact. This would be equivalent to 2 years of 24-7 service.

It will be understood that various aspects or details of the invention may be changed without departing from the scope of the invention. Furthermore, the foregoing description is for the purpose of illustration only, and not for the purpose of limitation—the invention being defined by the claims.

1. An apparatus for incubating droplets on a surface of a substrate, said apparatus comprising:
(a) a substrate stage for moving the substrate from a dispensing region to an incubating region;
(b) a liquid dispensing device in the dispensing region comprising a plurality of dispensing elements for dispensing droplets; and
(c) an incubation lid in the incubating region configured for moving between open and closed positions with respect to the substrate,
wherein the incubation lid and the substrate form an incubation chamber when the incubation lid is in a closed position.

2. The apparatus of claim 1, further comprising one or more thermal elements for increasing and/or decreasing a temperature of the substrate and/or the incubation chamber.

3. The apparatus of claim 1, further comprising
a lid actuator for moving the incubation lid in a Z-direction; and
a stage actuator for moving the substrate stage in an X-direction and/or a Y-direction.

4. The apparatus of claim 1, wherein the substrate stage comprises a cavity configured to hold the substrate.

5. The apparatus of claim 1, further comprising a substrate holder for holding the substrate, wherein the substrate holder is attached to or integral with the substrate stage.

6. The apparatus of claim 1, wherein the substrate stage comprises a substrate thermal element.

7.-8. (canceled)

9. The apparatus of claim 1, wherein the incubation lid comprises an incubation lid thermal element.

10.-11. (canceled)

12. The apparatus of claim 1, further comprising an evaporation cover that creates a head space in a dispensing region and/or between the dispensing region and the incubating region.

13. The apparatus of claim 12, wherein the evaporation cover comprises one or more apertures for receiving the incubation lid, such that the apertures correspond to the incubating regions.

14. The apparatus of claim 1, wherein the incubation lid comprises a lid ceiling and at least one lid wall that define an incubation chamber.

15. (canceled)

16. The apparatus of claim 14, wherein the at least one lid wall extends from about 200 to about 300 micrometers.

17. (canceled)

18. The apparatus of claim 1, wherein the incubation lid comprises a fluid inlet and a fluid outlet.

19. The apparatus of claim 18, wherein the fluid inlet is fluidically connected to a reservoir.

20.-22. (canceled)

23. The apparatus of claim 1, wherein the at least one lid wall comprises a lid end distal from the incubation lid ceiling, wherein the incubation lid end is configured to contact the substrate stage or the substrate held by the stage.

24. The apparatus of claim 23, wherein the incubation lid end is configured to form a fluid-tight seal with the substrate stage and/or with the substrate held by the substrate stage.

25. The apparatus of claim 1, wherein the incubation lid comprises an inflatable seal configured to contact the substrate stage and/or the substrate held by the substrate stage.

26. (canceled)

27. The apparatus of claim 1, further comprising a controller in signal communication with the substrate stage or with a stage actuator for moving the substrate stage in an X-direction and/or a Y-direction.

28. The apparatus of claim 26, further comprising one or more positional sensors for sensing a position of the substrate stage, wherein the one or more positional sensors are in signal communication with the controller.

29. The apparatus of claim 1, further comprising a controller in signal communication with the incubation lid or with a lid actuator for moving the incubation lid in a Z-direction.

30. A method for incubating droplets, the method comprising:
dispensing droplets onto a top surface of a substrate while the substrate is positioned in a dispensing region;
moving the substrate to an incubating region;
forming an incubation volume that substantially encloses the droplets; and
incubating the droplets in the incubation volume.

31.-60. (canceled)
